(19) United States
(12) Patent Application Publication
(10) Pub. No.: US 2008/0134275 A1
(43) Pub. Date: Jun. 5, 2008

(54) BROADCAST RECEPTION APPARATUS AND BROADCAST RECEPTION METHOD

(75) Inventor: Hiroyoshi Iketo, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/948,066

(22) Filed: Nov. 30, 2007

(30) Foreign Application Priority Data
Nov. 30, 2006 (JP) 2006-324993

(51) Int. Cl. H04N 7/00

(52) U.S. Cl. 725/131

(57) ABSTRACT

According to one embodiment, a broadcast reception apparatus includes a first tuner section which demodulates a broadcast signal and outputs audio and video signals, a second tuner section which is operated independently from the first tuner section, and a control section which receives broadcast signals of respective channels of the second tuner section, determines whether or not any one of broadcasts of the respective channels is set in a rest state, and performs a control operation to skip a channel set in the rest state when the channels of one of the first and second tuner sections are selected if the broadcast of the above channel is detected to be set in the rest state.

### CROSS-REFERENCE TO RELATED APPLICATIONS

This application is based upon and claims the benefit of priority from Japanese Patent Application No. 2006-324993, filed Nov. 30, 2006, the entire contents of which are incorporated herein by reference.

### BACKGROUND

1. Field

One embodiment of the present invention relates to a broadcast reception apparatus having a tuner which performs a skip process for channels and a broadcast reception method.

2. Description of the Related Art

Conventionally, in a digital television receiver, when channels are changed, the registered channels are sequentially selected in a registered order by continuously depressing the UP key or DOWN key of a remote control key, for example. However, when a broadcast corresponding to one of the registered channels is set in a rest state because of the middle of the night, there occurs a possibility that the user will tune to a channel in which a TV program cannot be viewed. In order to avoid this, the technique of the broadcast reception apparatus for skipping the channel which is now set in the rest state and automatically tuning to a next registered channel is known.

In Patent Document 1 (Jpn. Pat. Appln. KOKAI Publication No. S63-36608), a television receiver having a circuit which detects whether a program of a certain channel is broadcasted or not and a memory which stores a flag determining whether the channel is to be skipped or not is disclosed.

However, in the conventional technique disclosed in Patent Document 1, since one tuner is used to detect whether the channel is set in the rest state or not, there occurs a problem that the user cannot detect the rest state of another channel while viewing a program of still another channel.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of the configuration of a broadcast reception apparatus according to one embodiment of this invention.

FIG. 2 is a flowchart for illustrating one example of a skip flag setting process of the broadcast reception apparatus according to one embodiment of this invention.

FIG. 3 is a flowchart for illustrating one example of a skip flag setting process using EPG information of the broadcast reception apparatus according to one embodiment of this invention.

FIG. 4 is a flowchart for illustrating one example of a channel skip process using a skip flag of the broadcast reception apparatus according to one embodiment of this invention.

FIG. 5 is a flowchart for illustrating another example of a channel skip process using a skip flag of the broadcast reception apparatus according to one embodiment of this invention.

FIG. 6 is an explanatory view showing one example of a display screen which displays the presence of a skip flag of the broadcast reception apparatus according to one embodiment of this invention.

### DETAILED DESCRIPTION

Various embodiments according to the invention will be described hereinafter with reference to the accompanying drawings. In general, according to one embodiment of the invention, a broadcast reception apparatus comprising: a first tuner section which demodulates a broadcast signal and outputs audio and video signals, a second tuner section which is operated independently from the first tuner section, and a control section which receives broadcast signals of respective channels of the second tuner section, determines whether any one of broadcasts of the channels is set in a rest state, and performs a control operation to skip a channel which is set in the rest state when the channels of one of the first and second tuner sections are selected if the above channel is detected to be set in the rest state.

Now, one embodiment of this invention is explained in detail with reference to the accompanying drawings.

### Broadcast Reception Apparatus According to One Embodiment of this Invention

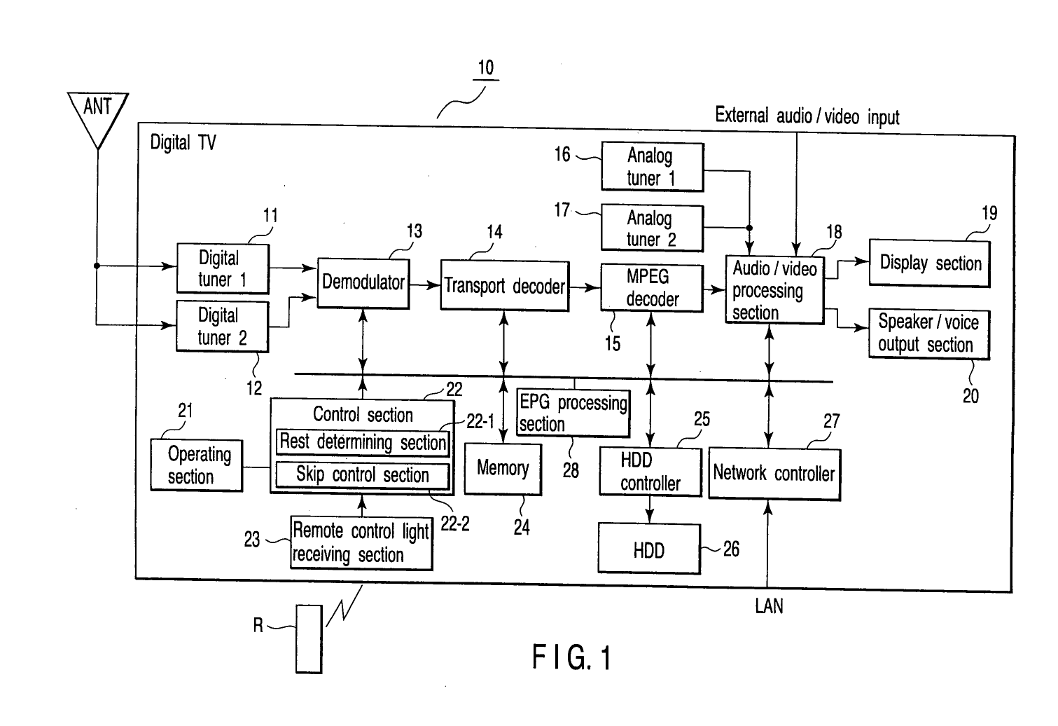

One example of a broadcast reception apparatus according to one embodiment of this invention is explained in detail with reference to the accompanying drawings. FIG. 1 is a block diagram showing one example of the configuration of a broadcast reception apparatus according to one embodiment of this invention. In FIG. 1, a broadcast reception apparatus 1 which is a digital television receiver includes a first digital tuner 11 and second digital tuner 12 which are connected to an antenna to receive a digital terrestrial broadcast signal or digital satellite signal, a demodulator 13 which is supplied with reception signals from the digital tuners 11, 12, and a transport decoder 14 which receives a demodulation signal demodulated by the demodulator 13.

Further, the broadcast reception apparatus 1 includes an MPEG decoder 15 which subjects a decode signal output from the transport decoder 14 to an MPEG decoding process, a first analog tuner 16 and second analog tuner 17 which are connected to an antenna to receive an analog terrestrial broadcast signal or analog satellite signal, an audio/video processing section 18 which is supplied with signals from the analog tuners 16, 17 and video and audio signals from an external DVD player or the like, a display section 19 which displays a video image in response to a video signal from the audio/video processing section 18, and a speaker 20 which outputs a voice.

The broadcast reception apparatus 1 further includes an operating section 21 having a power switch, channel UP/DOWN switches and the like, a remote control light receiving section 23 which receives an operation signal from a remote controller R, and a control section 22 which controls the operations of the respective units of the whole apparatus in response to operation signals from the above operating sections. Particularly, the control section 22 includes a rest determining section 22-1 which automatically detects a rest state of the channel in the middle of the night or the like and a skip control section 22-2 which sets a channel skip based on the detection result of the rest state of the channel.

Further, for example, the broadcast reception apparatus 1 includes a nonvolatile memory 24, an HDD controller 25 and HDD 26 for a volatile storage medium, a network controller 27 connected to an external communication device such as a LAN, and an EPG processing section 28 which manages EPG (Electronic ProGram) information extracted from the broadcast signal or the like.

(Basic Operation)

The broadcast reception apparatus 10 with the above configuration selects a broadcast signal received from the antenna by use of the first digital tuner 11 or the like and supplies an audio/video signal obtained by demodulating the thus selected broadcast signal by use of the demodulator 13, decoding the demodulated signal by use of the transport decoder 14 and decoding the decoded signal by use of the MPEG decoder 15 to the audio/video processing section 18. The audio/video signal supplied to the audio/video processing section 18 is subjected to a video process such as a scale conversion process, the audio signal is subjected to an amplifying process, a video image corresponding to the video signal is displayed on the display section 19 and a voice signal is output from the speaker 20.

(Channel Skip Process)

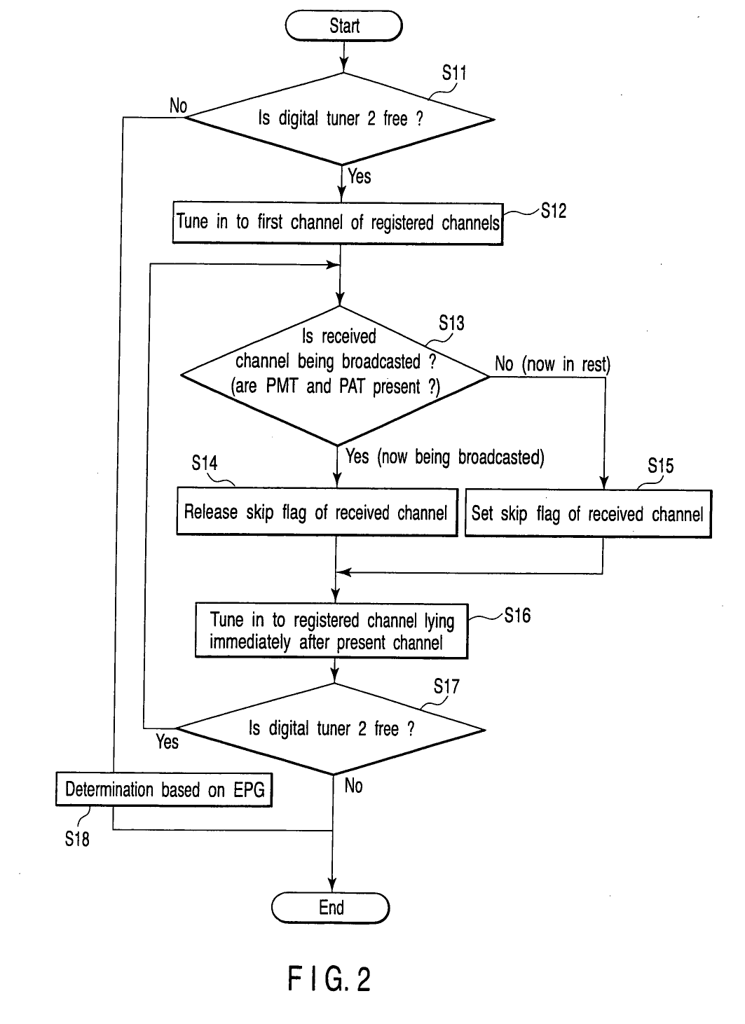

Next, the channel skip process performed by the broadcast reception apparatus 10 is explained in detail with reference to the flowcharts shown in FIGS. 2 to 5. FIG. 2 is a flowchart for illustrating one example of a skip flag setting process of the broadcast reception apparatus according to one embodiment of this invention.

The steps in the flowcharts shown in FIGS. 2 to 5 can be replaced by circuit blocks, and therefore, the respective steps in each of the flowcharts can all be redefined as blocks.

First, the channel skip process in the present embodiment is explained below.

1. A channel set in the rest state in the background is searched for by using a tuner different from the tuner used for viewing a TV program and information indicating the channel set in the rest state is previously stored. When the user changes the channels and if it is determined with reference to the memory information that the channel is a to-be-skipped channel, the channel is automatically skipped. By thus performing the above operation, the automatic skip operation is performed without lowering the tuning operation speed.

2. A to-be-skipped channel is searched for based on EPG information instead of searching for a channel set in the rest state by use of a different tuner.

Skip Flag Setting Process

Next, the skip flag setting process is explained. A method using a skip flag is explained as a method for skipping a channel, but it is not always necessary to use the method using the skip flag and it is preferable to realize the channel skip operation by use of another method.

The skip flag setting process is performed as follows. As shown in FIG. 2, in the broadcast reception apparatus 10, the rest determining section 22-1 of the control section 22 first determines whether or not the second digital tuner 12 is not yet used (whether or not it is not set in a state in which it is used to display the signal on the display section 19, output the signal to the output section 20 or record the signal in the HDD 26) (step S11). A state in which the power supply voltage is simply supplied to the tuner section is not considered as a now-in-use state. Further, the first digital tuner 11 is used while the second digital tuner 12 is being used.

When the second digital tuner 12 is now in use as described above, a process of detecting a rest of a program by use of EPG (electronic program) information is performed as will be described later with reference to the flowchart shown in FIG. 4 (step S12).

In the step S11, if the rest determining section 22-1 determines that the second digital tuner 12 is free, the first channel of the registered channels is tuned by use of the second digital tuner 12 (step S12). For example, the rest determining section 22-1 of the control section 22 selects “1ch” and determines whether a program corresponding to the channel now received is being broadcasted or not according to whether or not PMT and PAT of the reception signal from the second digital tuner 12 are present (step S13).

If PMT and PAT of the reception signal are present, the rest determining section 22-1 of the control section 22 determines that the program is now broadcasted and if the skip flag of the channel which is now received is set, it releases the setting of the skip flag (step S14). Further, if PMT and PAT of the reception signal are not present, the rest determining section 22-1 of the control section 22 sets a skip flag of the channel which is now received (step S15). The skip flag is stored into the memory 24 by the rest determining section 22-1.

In this case, it is preferable to display a channel which is determined to be skipped on the display section 19 as indicated by a reference numeral 31 shown in FIG. 6 by causing the user to freely set a display mode.

Then, a next channel of the registered channels is tuned by the second tuner 12 (step S16). It is confirmed again that the second tuner 12 is free and the process proceeds to the step S13 to determine the rest state of the next channel and set and release the skip flag. When the final one of the registered channels is reached, the first registered channel is tuned again.

Thus, the broadcasting state and rest state of the channel are monitored and the setting and releasing processes for the skip flag are performed for all of the registered channels. In the step S16, if the second tuner 12 is set in a now-in-use state to display the signal on the display section 19, output the signal to the output section 20, record the signal in the HDD 26 or the like, the skip flag setting process is terminated.

By performing the above operations at every preset period of time while the power supply to the television receiver is ON or at the standby time, skip flags indicating that a corresponding program is being broadcasted or not are stored into the memory 24 for all of the registered channels.

Skip Flag Setting Process using EPG Information

In the method described before, there are restrictions that a plurality of tuners are necessary and a tuner which is not used for viewing a TV program must be free. However, in the following embodiment, the above restrictions are eliminated by using the EPG. The automatic skip operation becomes effective only when a program rest is described on the EPG. There occurs another restriction that a channel on which a signal cannot be temporarily received due to a local environmental factor such as a weak electric field cannot be recognized as a to-be-skipped object. Therefore, a method using a combination of the method using a plurality of tuners and the method using the EPG may be preferably used.

That is, the EPG processing section 28 of the broadcast reception apparatus 10 extracts EPG information from the server via a network or a broadcast signal via the digital tuners 11, 12 in the flowchart of FIG. 4 (step S21). Next, the rest determining section 22-1 searches for a channel now set in the broadcasting rest state based on the EPG information (step S22). Then, a skip flag is set for the channel set in the rest state, skip flags for the other channels are released and the process is terminated (step S23).

By performing the above process at every preset period of time while the power supply to the television receiver is ON or in the standby mode, skip flags indicating that corresponding programs are being broadcasted or not are stored into the memory for all of the registered channels.

By the above process, in the broadcast reception apparatus according to one embodiment of this invention, it is possible to prevent occurrence of noises and rapidly perform a tuning operation by a function of automatically skipping a channel which is set in the broadcasting rest state due to the middle of the night or the like when the user sequentially changes the channels by use of the channel UP/DOWN keys of the television receiver.

Channel Skip Process

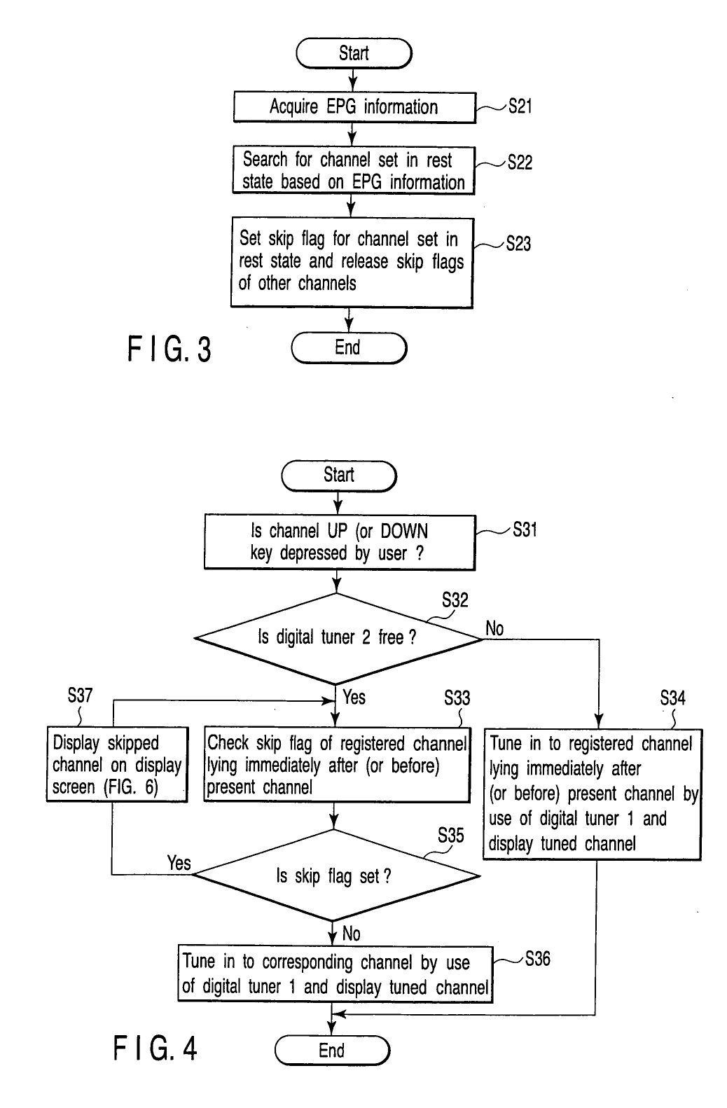

Next, one example of the channel skip process using a thus updated skip flag is explained with reference to a flowchart. FIG. 3 is a flowchart for illustrating one example of the channel skip process using a skip flag of the broadcast reception apparatus according to one embodiment of this invention.

In the flowchart of FIG. 3, if the user depresses the UP (or DOWN) key of a channel of the remote controller R (step S31), the skip control section 22-2 determines whether the second tuner 12 is free or not (step S32). If the second tuner 12 is free, a skip flag of the registered channel which lies immediately after (or before) the present channel is checked. In this step, since the actual tuning operation is not performed and the skip flag stored in the memory 24 is only referred to, the high-speed operation can be attained (step S33).

In this case, if the skip control section 22-2 determines that the skip flag is set (step S35), the channel is an automatically to-be-skipped object, and therefore, it is skipped without being selected and the process returns to the step S33. At this time, it is preferable to display the number 31 of the channel skipped on the display screen 19 as shown in FIG. 6 (step S37).

If the skip control section 22-2 determines that the skip flag is not set, the channel is not an automatically to-be-skipped object, and therefore, it is selected without being skipped and the channel is tuned by the first digital tuner 11 and displayed (step S36).

Further, in the step S11, if the second digital tuner 12 is not free, the automatic skip function is not used, a channel which lies immediately after (or before) the present channel is selected by the first digital tuner 11 and the process is terminated (step S34).

In this case, the reason why the automatic skip function is not used is that the channel set in the rest state cannot be searched for and it cannot be ensured that the skip flag stored in the memory is the newest when the second digital tuner 12 is used for recording or outputting a signal to the output section and is not free. If the channel is automatically skipped based on the old flag, there occurs a problem that the channel will be skipped even when the broadcast thereof is restarted later.

As described above, the automatic skip operation can be realized without lowering the tuning operation speed by using a tuner different from the tuner for viewing a TV program and searching for a channel now set in the rest state in the background although there occur some restrictions on the use thereof.

It is also preferable to perform the channel skip process only by using the tuner for viewing a TV program.

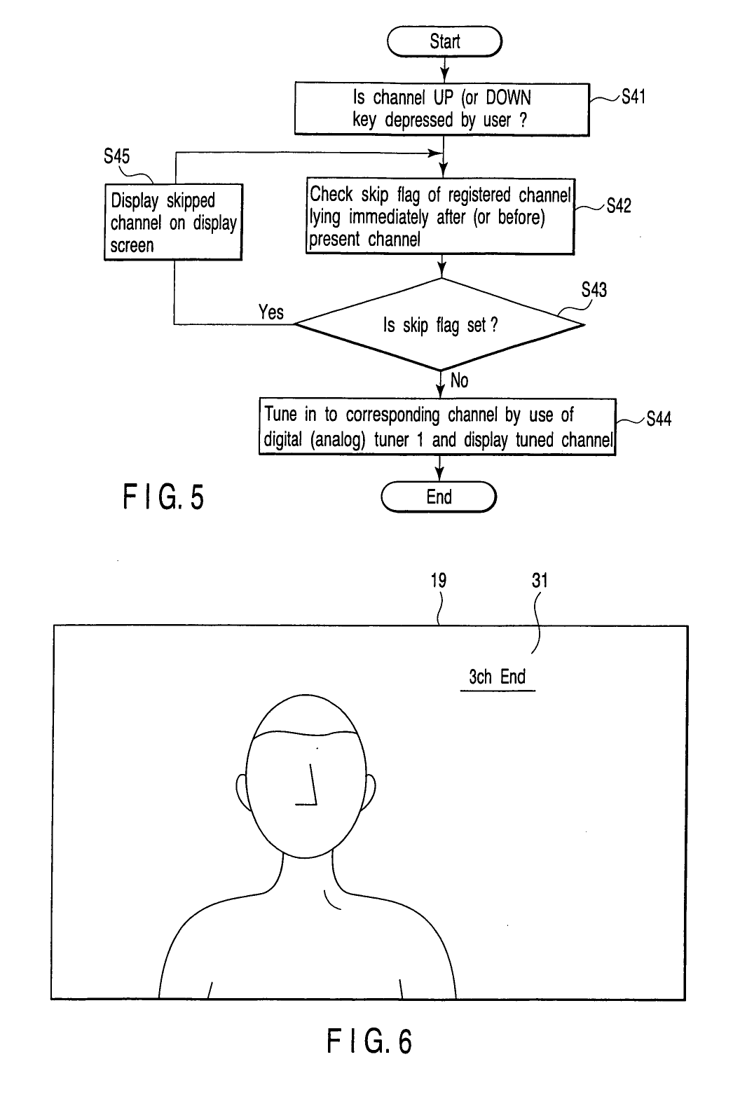

FIG. 5 is a flowchart for illustrating another example of the channel skip process using a skip flag of the broadcast reception apparatus according to one embodiment of this invention.

In the flowchart shown in FIG. 5, when the user depresses the UP (or DOWN) key of a channel of the remote control key R or the like (step S41), the skip control section 22-2 checks a skip flag of the registered channel which lies immediately after (or before) the present channel (step S42). In this step, since the actual tuning operation is not performed and the skip flag stored in the memory 24 is only referred to, the high-speed operation can be attained.

In this case, if the skip control section 22-2 determines that the skip flag is set (step S43), the channel is an automatically to-be-skipped object, and therefore, it is skipped without being selected and the process returns to the step S42. At this time, it is preferable to display the number 31 of the channel skipped on the display screen 19 as shown in FIG. 6 (step S45).

If the skip control section 22-2 determines that the skip flag is not set, the channel is not an automatically to-be-skipped object, and therefore, it is selected without being skipped and the channel is tuned by the first digital tuner 11 and displayed (step S44).

As described above, it is preferable to perform the automatic skip operation only by using the tuner for viewing a TV program. At this time, it is desirable to avoid the situation in which the channel is skipped although the channel having been set in the rest state is restarted by increasing the number of step flag setting processes.

A case wherein the digital tuners 11, 12 are used as an example is explained, but the same operation can be performed when the analog tuners 16, 17 are used.

In the embodiments described above, those who are skilled in the art can realize the present invention and easily think of various modifications of the embodiments. Further, those who have no inventive abilities can apply this invention to various embodiments. Therefore, this invention can be applied to a wide range which is not inconsistent with the disclosed principle and new features and is not limited to the above embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast reception apparatus comprising:
a first tuner section which demodulates a broadcast signal and outputs audio and video signals,
a second tuner section which is operated independently from the first tuner section, and
a control section which receives broadcast signals of respective channels of the second tuner section, determines whether any one of broadcasts of the channels is set in a rest state, and performs a control operation to skip a channel which is set in the rest state when the channels of one of the first and second tuner sections are selected if the above channel is detected to be set in the rest state.

2. The broadcast reception apparatus according to claim 1, wherein the control section receives broadcast signals of the respective channels of the second tuner section, determines whether the broadcast is set in the rest state and performs a control operation to skip a channel which is set in the rest state when the channels of one of the first and second tuner sections are selected in a case where a video image corresponding to the audio and video signals from the second tuner section is not displayed on a display section, is not output from an output terminal and is not recorded in a recording section if the above channel is detected to be set in the rest state.

3. The broadcast reception apparatus according to claim 1, wherein the control section sets a skip flag when the control section determines that the broadcast of at least one of the channels is set in the rest state and performs a channel skip operation by using the skip flag when the channels of the first and second tuner sections are selected.

4. The broadcast reception apparatus according to claim 1, wherein the control section determines whether the broadcast is interrupted depending on whether PMT and PAT are present in the broadcast signal.

5. The broadcast reception apparatus according to claim 1, wherein the control section acquires EPG information of the broadcast signal and determines whether the broadcast is interrupted based on the acquired EPG information when a video image corresponding to the audio and video signals from the second tuner section is displayed on a display section, output from an output terminal or recorded in a recording section.

6. The broadcast reception apparatus according to claim 1, wherein the control section generates an image signal to display a channel skipped according to the skip flag if the channel skipped according to the skip flag is present during a channel operation performed according to a channel operation signal of the first and second tuner sections.

7. The broadcast reception apparatus according to claim 1, wherein the control section receives a broadcast signal of each channel by use of one of the first and second tuner sections while the broadcast signal is being displayed on a display section and displays a channel on the display section if the control section determines that the broadcast of the channel is set in the rest state.

8. A broadcast reception apparatus comprising:
a first tuner section which demodulates a broadcast signal and outputs audio and video signals,
a second tuner section which is operated independently from the first tuner section,
a control section which receives broadcast signals of respective channels of the second tuner section, determines whether any one of broadcasts of the channels is set in a rest state, and performs a control operation to skip a channel which is set in the rest state when the channels of one of the first and second tuner sections are selected if the above channel is detected to be set in the rest state, and
a display section which displays an image corresponding to the audio and video signals output from the first tuner section on a display screen.

9. A broadcast reception method of a broadcast reception apparatus including a first tuner section which demodulates a broadcast signal and outputs audio and video signals and a second tuner section which is operated independently from the first tuner section, comprising:
receiving broadcast signals of respective channels of the second tuner section,
determining whether any one of broadcasts of the channels is set in a rest state, and
performing a control operation to skip a channel which is set in the rest state when the channels of one of the first and second tuner sections are selected if the above channel is detected to be set in the rest state.
